(19) United States
(12) Patent Application Publication
(10) Pub. No.: US 2005/0231153 A1
(43) Pub. Date: Oct. 20, 2005

(54) High voltage isolation detection of a fuel cell system using magnetic field cancellation

(76) Inventors: Scott Dewey, Dansville, NY (US); John Wheat, Rochester, NY (US)

Correspondence Address: CARY W. BROOKS;General Motors Corporation, Legal Staff, Mail Code 482-C23-B21, P.O. Box 300, Detroit, MI, 48265-4717, US

(21) Appl. No.: 10/828,420

(22) Filed: Apr. 20, 2004

(51) Int. Cl. H01M 10/44

(52) U.S. Cl. 320/101

(57) ABSTRACT

A technique for providing high voltage isolation detection in a fuel cell system. The fuel cell system includes a high voltage component and a fuel cell stack. A first conductor is electrically coupled to a positive terminal and the high voltage component, and a second conductor is electrically coupled to a negative terminal and the high voltage component. Current propagating through the first and second conductors is in opposite directions. The first and second conductors extend through an opening in a torroid. The current propagating through the conductors generate magnetic fields that are concentrated by the torroid. A sensor is positioned within the torroid that detects the magnetic fields. If the high voltage component is electrically isolated, then the magnetic fields cancel. If the high voltage component is not isolated, the magnetic fields do not cancel, and the sensor provides a signal indicative of the isolation fault.

### BACKGROUND OF THE INVENTION

1. Field of the Invention

This invention relates generally to a system for providing high voltage isolation detection in a fuel cell system and, more particularly, to an isolation detection system for providing high voltage isolation detection in a fuel cell system, where the isolation detection system employs magnetic field cancellation.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer electrolyte proton conducting membrane, such as a perflorinated acid membrane. The anode and cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Many fuel cells are typically combined in a fuel cell stack to generate the desired power. The fuel cell stack receives a cathode charge gas that includes oxygen, and is typically a flow of forced air from a compressor. Not all of the oxygen in the air is consumed by the stack and some of the air is output as a cathode exhaust gas that may include water as a stack by-product.

FIG. 1 is a simplified plan view of a fuel cell stack 10 enclosed in a housing 12. Several of the fuel cell stacks 10 can be configured in a multi-stack system. The stack 10 includes a positive terminal (anode) 14 and a negative terminal (cathode) 16 that are electrically coupled to the respective terminals of the stack 10 within the housing 12. A coolant loop flows through the housing 12 to cool the stack 10 during operation. A leakage current exists that flows through the coolant loop. The resistance Rₙ identifies a negative conductive path between the negative terminal 16 and ground (vehicle chassis) through the coolant loop, and the resistance Rₚ identifies a positive conductive path between the positive terminal 14 and ground through the coolant loop to depict the leakage current. It is known that the resistance Rₙ will be significantly greater than the resistance Rₚ.

For safety purposes, the high voltage of the fuel cell stack and the high voltage components that the stack drives need to be electrically isolated by a suitable isolation system. The isolation system prevents a person from being electrocuted by the system, such as coming in contact with the positive terminal 14 or the negative terminal 16 and ground, such as the vehicle chassis. The known isolation systems for a fuel cell system typically prevent a current feed-back path from the negative terminal 16 to the positive terminal 14, and vice versa. For example, resistors are provided to limit the current flow between the positive terminal 14 and ground and the negative terminal 16 and ground. The leakage current through the coolant loop is typically small enough so as to not pose an isolation problem.

Fault isolation detection systems are also necessary to determine if the isolation system is compromised to prevent the potential for electrical shock. One known fault isolation detection system employed in fuel cell systems includes monitoring a voltage shift between the positive terminal of the stack and chassis ground and the negative terminal of the stack and chassis ground. As discussed above, there is a known ratio (Rₚ/Rₙ) between these two voltages as a result of the leakage current through the stack coolant. If the resistance Rₚ or Rₙ goes down, indicating a fault condition, the voltage ratio will change. Monitoring the high voltage isolation of a fuel cell system in this manner requires very sensitive circuits that can detect small voltage shifts.

### SUMMARY OF THE INVENTION

In accordance with the teachings of the present invention, a technique for providing high voltage isolation detection in a fuel cell system is disclosed that employs magnetic field cancellation. The fuel cell system includes a high voltage component driven by a fuel cell stack, where the stack includes a positive terminal and a negative terminal. A first conductor is electrically coupled to the positive terminal and the high voltage component, and a second conductor is electrically coupled to the negative terminal and the high voltage component to provide the electrical circuit. Current propagating through the first and second conductors is in opposite directions.

The fuel cell system further includes a torroid having an opening, where the first and second conductors extend through the opening. The current propagating through the first and second conductors generates magnetic fields that are concentrated by the torroid. A sensor is positioned within the torroid that detects the magnetic fields. If the high voltage component is electrically isolated, the currents will be the same and the magnetic fields will cancel. If the high voltage component is not electrically isolated, the currents will be different, the magnetic fields will not cancel, and the sensor will provide a signal indicative of the isolation fault.

Additional advantages and features of the present invention will become apparent from the following description and appended claims, taken in conjunction with the accompanying drawings.

### BRIEF DESCRIPTION OF THE DRAWINGS

FIG. 1 is a plan view of a fuel cell stack system showing the resistances between the stack anode and ground through the coolant loop and the stack cathode and ground through the coolant loop;

FIG. 2 is a schematic plan view of a current carrying conductor extending through a torroid;

FIG. 3 is a schematic plan view of two current carrying conductors extending through a torroid, where the magnetic fields generated by the conductors cancel; and

FIG. 4 is a schematic plan view of a high voltage isolation detection system for a fuel cell system, according to an embodiment of the present invention.

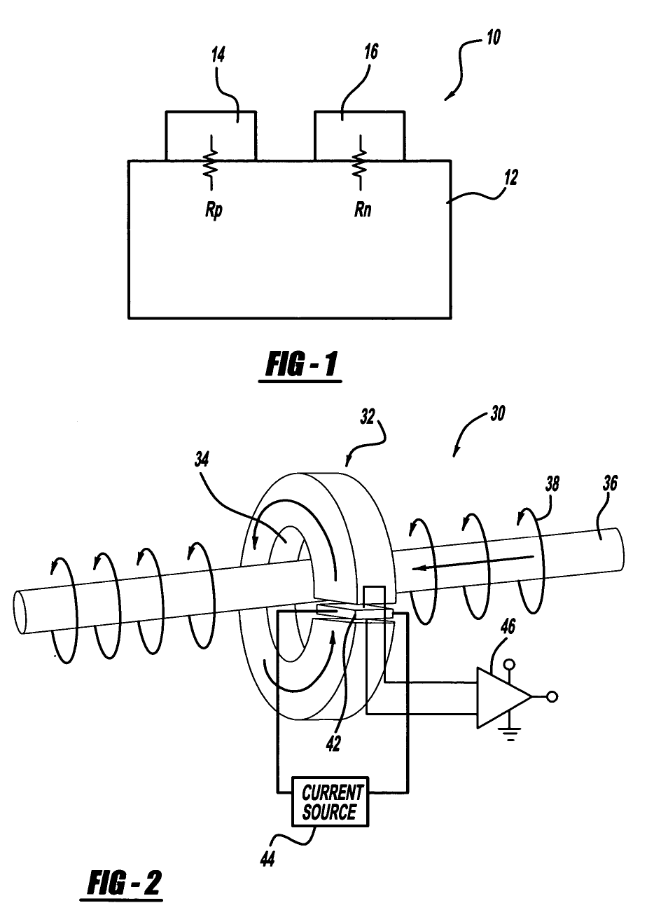

### DETAILED DESCRIPTION OF THE EMBODIMENTS

The following discussion of the embodiments of the invention directed to a technique for providing high voltage isolation detection in a fuel cell system is merely exemplary in nature, and is in no way intended to limit the invention or its applications or uses. For example, the fault isolation detection system of the invention is described as having application for a fuel cell system for a vehicle. However, the fault isolation detection system of the invention has application for other electrical systems.

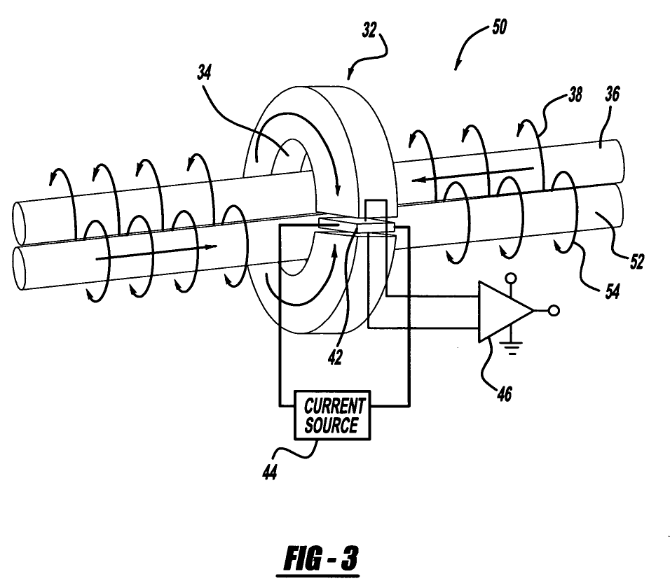

FIG. 2 is a schematic plan view of an electrical system 30 including a ferrite torroid 32 having a center opening 34. A conductor 36 extends through the opening 34, and carries a current that generates a magnetic field 38. The greater the current flow through the conductor 36, the greater the magnetic field 38. The magnetic field 38 is concentrated by the torroid 32. A magnetic sensor 42, such as a Hall effect sensor, is positioned within the torroid 32, as shown, and a current source 44 applies a current to the sensor 42. The magnetic field in the torroid 32 creates a voltage potential between plates in the sensor 42. An operational amplifier 46 measures and amplifies the voltage potential, and thus the current flowing through the conductor 36.

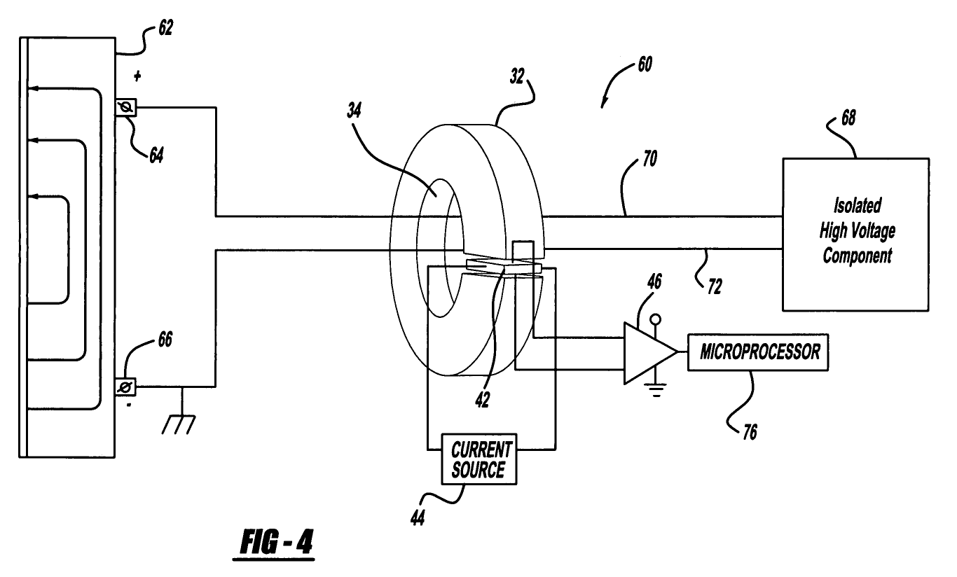

FIG. 3 is a schematic plan view of another electrical system 50 including the same elements as the electrical system 30 identified by the same reference numeral. The system 50 includes a second conductor 52 extending through the opening 34. The second conductor 52 has a current traveling in an opposite direction to the current traveling through the conductor 36 so that it generates a magnetic field 54 in an opposite direction to the magnetic field 38. If the two currents traveling through the conductors 36 and 52 are equal, the magnetic fields 38 and 54 will cancel. Because of the magnetic field cancellation, the sensor 42 will not detect a magnetic field, and thus, the output voltage of the amplifier 46 will be zero.

FIG. 4 is a schematic plan view of a fuel cell system 60 that provides high voltage isolation fault detection based on the principle of the electrical system 50, where like elements are identified by the same reference number. The system 60 includes a fuel cell stack 62 having a positive stack terminal 64 and a negative stack terminal 66. The positive terminal 64 is electrically coupled to an isolated high voltage component 68 by an electrical conductor 70, such as a wire, and the negative terminal 66 is electrically coupled to the high voltage component 68 by an electrical conductor 72, such as a wire. The isolated component 68 can be a high voltage vehicle component driven by the fuel cell stack 62. The conductors 70 and 72 extend through the opening 34 in the torroid 32. The fuel cell stack 62 generates an electrical current where the current exiting the stack 62 at the negative terminal 66 is the same as the current entering the stack 62 at the positive terminal 64 during normal stack operation. Therefore, the magnetic fields generated by the current flow in the conductors 70 and 72 should cancel, and the output of the amplifier 46 should be zero during normal stack operation.

If the system isolation fails and the high voltage component 68 becomes electrically coupled directly to ground, some of the current exiting the stack 62 on the conductor 72 will not be returned to the fuel cell stack 62 on the conductor 70, and will be directed to chassis ground. Thus, the current propagating through the conductors 70 and 72 will be different depending on the magnitude of the isolation fault. This indirect return path of the current back to the stack 62 will cause an unbalanced condition of the magnetic fields generated by the conductors 70 and 72. The magnetic field difference between the magnetic fields generated by the conductors 70 and 72 will be detected by the sensor 42. The sensor 42 will provide an output signal to the amplifier 46 indicative of the combined magnetic fields.

The signal from the sensor is amplified by the amplifier 46. The output signal of the amplifier 46 is received by a controller 76, which will take the appropriate action, such as shutting the fuel cell system down. By setting a threshold point for the difference between the currents traveling through the conductors 70 and 72, the controller 76 can alert an overall system controller or take its own remedial action.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A fuel cell system comprising:
a high voltage component;
a fuel cell stack including a positive terminal and a negative terminal;
a first conductor electrically coupled to the positive terminal and the high voltage component;
a second conductor electrically coupled to the negative terminal and the high voltage component, wherein a current propagating through the first and second conductors is in opposite directions;
a magnetic field concentrator including an opening, said first and second conductors extending through the opening, wherein a current propagating through the first and second conductors generate magnetic fields that are concentrated by the magnetic field concentrator; and
a magnetic sensor positioned relative to the magnetic field concentrator, said sensor detecting the magnetic field in the magnetic field concentrator and providing a difference signal representative of the difference between the current propagating through the first conductor and the current propagating through the second conductor.

2. The system according to claim 1 further comprising an amplifier, said amplifier being responsive to the difference signal from the sensor and providing an amplified output signal indicative of the difference between the current propagating through the first conductor and the current propagating through the second conductor.

3. The system according to claim 1 wherein the sensor is a Hall effect sensor.

4. The system according to claim 3 further comprising a current source, said current source providing a current to the sensor.

5. The system according to claim 1 wherein the magnetic field concentrator is a torroid.

6. The system according to claim 5 wherein the sensor is positioned within the torroid.

7. The system according to claim 5 wherein the torroid is a ferrite torroid.

8. The system according to claim 1 wherein the high voltage component is a vehicle component.

9. The system according to claim 8 wherein the difference signal generated by the sensor represents a fault detection of an electrical isolation system.

10. A fuel cell system comprising:
a high voltage component;
a fuel cell stack including a positive terminal and a negative terminal;
a first conductor electrically coupled to the positive terminal and the high voltage component;
a second conductor electrically coupled to the negative terminal and the high voltage component, wherein a current propagating through the first and second conductors is in opposite directions and generate magnetic fields; and
a magnetic sensor positioned relative to the first and second conductors, said sensor detecting a combined magnetic field and providing a difference signal representative of the difference between the current propagating through the first conductor and the current propagating through the second conductor, wherein the difference signal generated by the sensor represents a fault detection of an electrical isolation system.

11. The system according to claim 10 further comprising a torroid including an opening, said first and second conductors extending through the opening, said sensor being positioned within the torroid.

12. The system according to claim 10 further comprising an amplifier, said amplifier being responsive to the difference signal from the sensor and providing an amplified output signal indicative of the difference between the current propagating through the first conductor and the current propagating through the second conductor.

13. The system according to claim 10 wherein the sensor is a Hall effect sensor.

14. The system according to claim 10 wherein the high voltage component is a vehicle component.

15. A method of detecting a fault condition of an isolation system in a fuel cell system, said method comprising:
providing a high voltage component;
providing a fuel cell stack including a positive terminal and a negative terminal;
electrically coupling a first conductor to the positive terminal and the high voltage component;
electrically coupling a second conductor to the negative terminal and the high voltage component, wherein a current propagating through the first and second conductors is in opposite directions and generate magnetic fields;
detecting the magnetic fields generated by the first and second conductors; and
providing a signal representative of the difference between the current propagating through the first conductor and the current propagating through the second conductor from the detected magnetic field.

16. The method according to claim 15 wherein detecting the magnetic fields generated by the first and second conductors includes detecting the magnetic fields generated by the first and second conductors by a magnetic sensor.

17. The method according to claim 16 wherein detecting the magnetic fields generated by the first and second conductors includes detecting the magnetic fields generated by the first and second conductors by a magnetic sensor positioned within a torroid, wherein the first and second conductors extend through an opening in the torroid.

18. The method according to claim 15 wherein detecting the magnetic fields generated by the first and second conductors includes detecting the magnetic fields generated by the first and second conductors by a Hall effect sensor positioned within a torroid, wherein the first and second conductors extend through an opening in the torroid.

19. The method according to claim 15 wherein the high voltage component is a vehicle component.
